(19) United States
(12) Patent Application Publication
(10) Pub. No.: US 2013/0142482 A1
(43) Pub. Date: Jun. 6, 2013

(54) OPTICAL FIBER COUPLER WITH MALE PORT AND FEMALE PORT

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/473,806

(22) Filed: May 17, 2012

(30) Foreign Application Priority Data
Dec. 2, 2011 (TW) 100144401

(51) Int. Cl. G02B 6/32

(52) U.S. Cl. 385/33

(57) ABSTRACT

An optical fiber coupler includes a male port and a female port. The male port includes a main body, a positioning post and two lenses mounted on the body, and a first transmitting optical fiber and a first receiving optical fiber received in the main body. The first transmitting optical fiber and the first receiving optical fiber are coupled with corresponding optical fibers. The positioning post includes a columnar body and a conical frustum body. The female port includes a base body, a second transmitting optical fiber and a second receiving optical fiber received in the base body, two lenses coupling with the optical fibers. The base body defines a positioning hole corresponding to the positioning post. The positioning hole includes a columnar portion and a conical frustum portion.

### BACKGROUND

1. Technical Field

The present disclosure relates generally to coupling connectors, especially to an optical fiber coupler having a female port and a male port.

2. Description of Related Art

The optical fiber coupler may be used in an electronic device for transmitting data. The optical fiber coupler includes a male port and a female port coupled with the male port. In use, the male port is inserted into the female port, and lenses of the male port are aligned with lenses of the female port, thus an optical signal may be transmitted between the female port and the male port.

The male port may form a conical frustum positioning portion, and the female port may define a conical frustum positioning hole according to the positioning portion, to make sure the lenses of the male port precisely aligns with the lenses of the female port. Thus the sizes of the positioning portion and the positioning hole must be precise. The non-contact measurement may use an optical projector to emit optical signals to the positioning portion or positioning hole for size measurement. However, the positioning portion and the positioning hole are manufactured by electro discharge machining, thus the surface may be coarse, which results in imprecise measurements.

In addition, the contact measurement may use a probe to contact the positioning portion or positioning hole for measuring the sizes. However, the end of the probe is spherical, which results in the probe not contacting the base end of the positioning portion or the base end of the positioning hole. Thus a complex calculation is needed to obtain the size of the base end of the positioning portion or the size of the base end of the positioning hole.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of an optical fiber coupler.

FIG. 2 is an explored, isometric view of the optical fiber coupler shown in FIG. 1 including a male port and a female port.

FIG. 3 is similar to FIG. 2, but viewed from another aspect.

FIG. 4 is an enlarged, isometric view of circled portion IV of FIG. 2.

FIG. 5 is a section view of the female port shown in FIG. 3.

### DETAILED DESCRIPTION

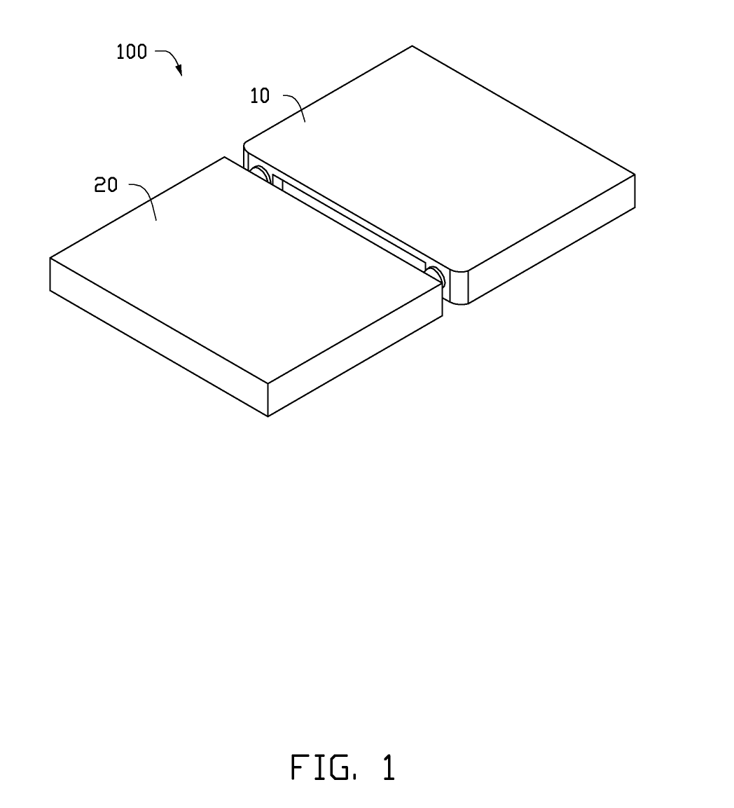

FIG. 1 is one embodiment of an optical fiber coupler 100 including a male port 10 and a female port 20. The female port 20 is mounted in an electronic device (not shown in FIG. 1), such as a computer, a printer, or a camera, for example. The male port 10 is portable, and may be coupled with the female port 20 to transmit data from one electronic device to another electronic device.

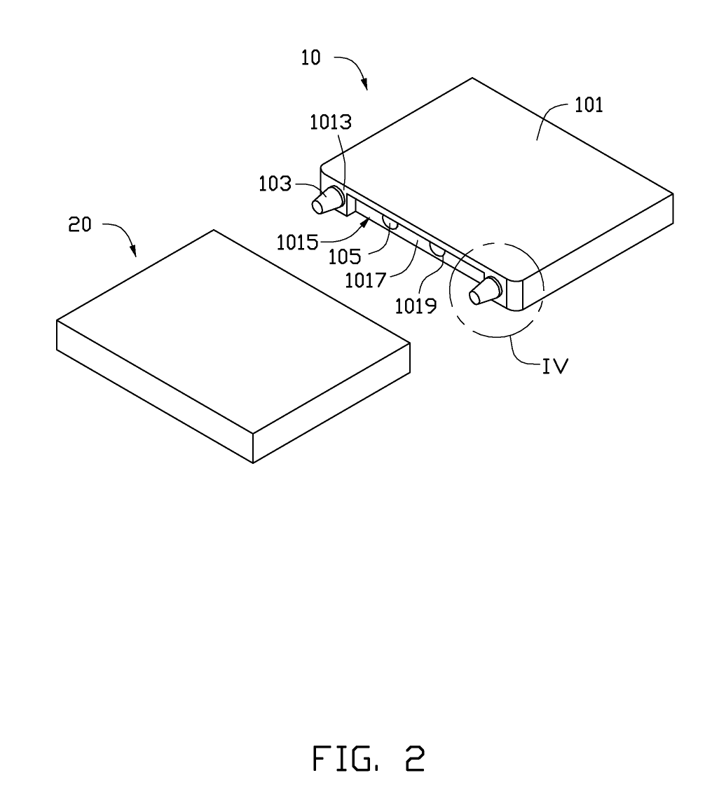

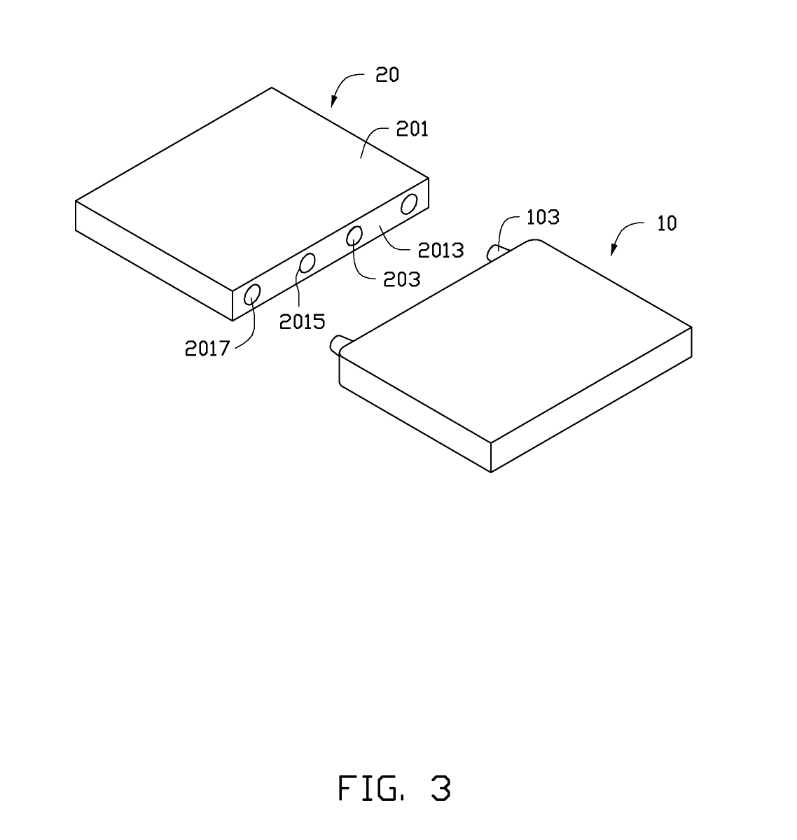

FIGS. 2 and 3 show the male port 10 including a main body 101, a pair of positioning posts 103, and a pair of male port lenses 105. The positioning posts 103 and the lenses 105 are mounted on a sidewall of the main body 101.

The main body 101 is a substantially rectangular plate, and includes a connecting surface 1013 facing the female port 10. The main body 101 defines a groove 1015 at a substantially middle portion of the connecting surface 1013. The groove 1015 includes a male port transmission surface 1017 at a bottom thereof. The male port transmission surface 1017 is parallel to the connecting surface 1013. The main body 101 further defines a pair of first receiving holes 1019 arranged apart on the male port transmission surface 1017 to receive the female port lenses 105. In the illustrated embodiment, the first receiving holes 1019 are substantially circular holes.

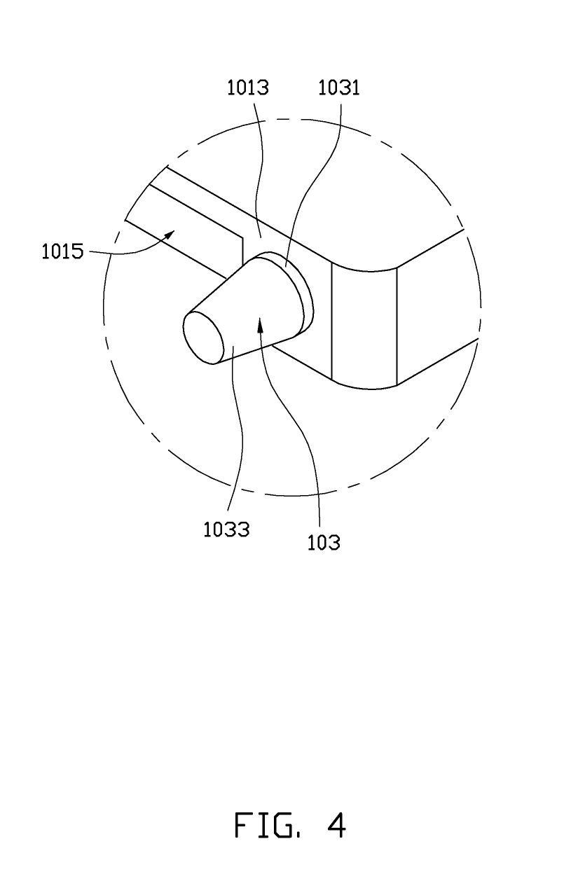

FIG. 4 shows the positioning posts 103 mounted on the connecting surface 1013 at two opposite sides of the groove 1015. The positioning posts 103 perpendicularly protrude from the connecting surface 1013 towards the female port 20. Each positioning post 103 includes a columnar body 1031 and a conical frustum body 1033. The columnar body 1031 protrudes from the connecting surface 1013, and the conical frustum body 1033 is formed at a side of the columnar body 1031 adjacent to the female port 20. A first end of the conical frustum body 1033 away from the columnar body 1031 is smaller than a second end adjacent to the columnar body 1031, i.e., a diameter of the first end is less than a diameter of the second end of the conical frustum body 1033. In other embodiments, the number of the positioning post 103 can be one, three, or four, for example.

The male port lenses 105 are received in corresponding first receiving holes 1019, and the male port lenses 105 protrude from the male port transmission surface 1017 towards the female port 20. In other embodiments, the number of the male port lenses 105 can be three, four or more, and the number of the first receiving holes 1019 is three, four or more, correspondingly.

The male port 10 further includes at least one first transmitting optical fiber (not shown) and at least one first receiving optical fiber (not shown). In the illustrated embodiment, there is one first transmitting optical fiber and one first receiving optical fiber. The first transmitting optical fiber and the first receiving optical fiber are received in the main body 101, and respectively coupled with corresponding male port lenses 105.

FIG. 3 shows the female port 20 including a base body 201 and a pair of female port lenses 203 mounted on the base body 201. The base body 201 is a substantially rectangular plate, and includes a female port transmission surface 2013 towards the male transmission surface 1017 of the male port 10. The base body 201 defines a pair of second receiving holes 2015 and a pair of positioning holes 2017 at the female port transmission surface 2013. The second receiving holes 2015 are arranged apart according to the first receiving holes 1019. The positioning holes 2017 are aligned with the second receiving holes 2015, and are located at two opposite sides of the second receiving holes 2015 according to the positioning posts 103. The positioning holes 2017 are for receiving the positioning posts 103, to precisely connect the male port 10 with the female port 20.

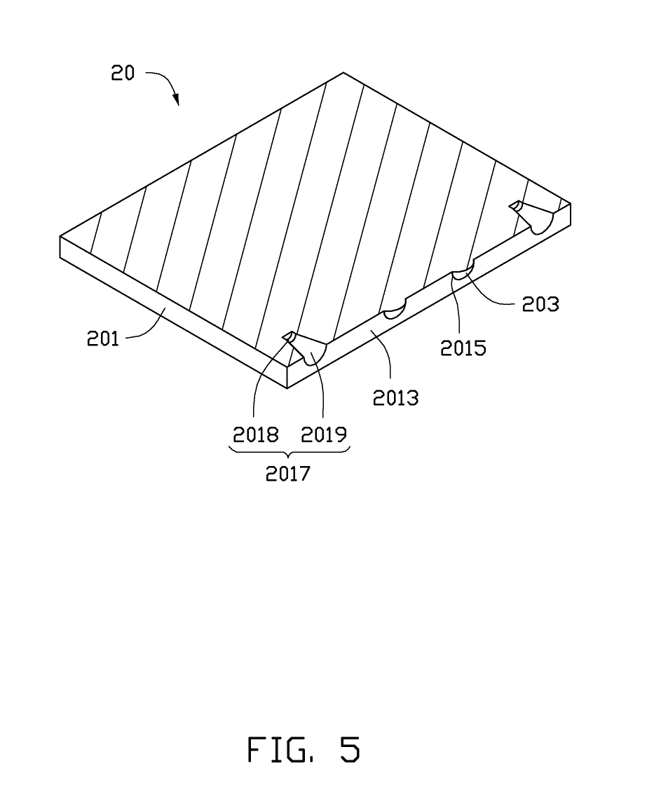

FIG. 5 shows each positioning hole 2017 includes a columnar portion 2018 and a conical frustum portion 2019. The columnar portion 2018 is located at a side of the conical frustum portion 2019 away from the female port transmission surface 2013. A first end of the conical frustum portion 2019 adjacent to the columnar portion 2018 is smaller than a second end away from the columnar portion 2018. In other embodiments, the number of the positioning holes 2017 can be one, three, or four, for example.

The female port lenses 203 are received in corresponding second receiving holes 2015, and the female male port lenses 203 protrude out from the male port transmission surface 2013 corresponding to the male port lenses 105. In other embodiments, the number of the female port lenses 203 can be three, four or more corresponding to the male port lenses 105.

The female port 20 further includes at least one second transmitting optical fiber (not shown) and at least one second receiving optical fiber (not shown). In the illustrated embodiment, there is one second transmitting optical fiber and one second receiving optical fiber. The second transmitting optical fiber and the second receiving optical fiber are received in the base body 201, and respectively couple with corresponding female port lenses 203.

In use, the male port 10 is engaged with the female port 20. The positioning posts 103 are inserted into the positioning holes 2017, thus the male port 10 is positioned relative to the female port 20. The male port lenses 105 are aligned with the corresponding female port lenses 203.

The conical frustum body 1033 is inserted into the conical frustum portion 2019, thus the engagement of the positioning post 103 with the positioning hole 2017 is convenient. Because the columnar body 1031 is designed adjacent to the connecting surface 1013, and the columnar portion 2018 is designed at the bottom of the positioning hole 2017, thus the end size of the positioning post 103 adjacent to the connecting surface 1013 is equal to the size of the columnar body 1031, and the end size of the positioning hole 2017 away from the female port transmission surface 2013 is equal to the size of the columnar position 2018. It is convenient to measure the size of the columnar body 1031 and the size of the columnar portion 2018 via a touch probe (not shown).

It is believed that the present embodiments and their advantages will be understood from the foregoing description, and it will be apparent that various changes may be made thereto without departing from the spirit and scope of the disclosure or sacrificing all of its material advantages.

What is claimed is:

1. An optical fiber coupler, comprising:
a male port comprising a main body, a positioning post, at least one first transmitting optical fiber, at least one first receiving optical fiber, and at least two male port lenses; the main body comprising a connecting surface, the positioning post and the at least two male port lenses mounted on the connecting surface; the at least one first transmitting optical fiber and the at least one first receiving optical fiber received in the main body and coupling with corresponding male port lenses; and
a female port coupled with the male port, the female port comprising a base body, at least one second transmitting optical fiber and at least one second receiving optical fiber received in the base body, and at least two female port lenses coupling with the at least one second transmitting optical fiber and the at least one second receiving optical fiber,
wherein the base body of the female port defines a positioning hole at a side thereof towards the male port corresponding to the positioning post; the positioning post is detachably engaged in the positioning hole; the positioning post comprises a columnar body adjacent to the main body and a conical frustum body extends from an end of the columnar body away from the main body towards the female port; the positioning hole comprises a columnar portion and a conical frustum portion adjacent to the columnar portion, the columnar portion is located at a bottom of the positioning hole.

2. The optical fiber coupler of claim 1, wherein a diameter of a first end of the conical frustum body away from the columnar body is less than that of a second end of the conical frustum body adjacent to the columnar body.

3. The optical fiber coupler of claim 1, wherein a diameter of a first end of the conical frustum portion adjacent to the columnar portion is less than that of a second end of the conical frustum portion away from the columnar portion.

4. The optical fiber coupler of claim 1, wherein the main body defines a groove at the connecting surface; the main body defines at least two first receiving holes at a bottom surface of the groove; the at least two male port lenses are received in corresponding first receiving holes; and the at least two male port lenses protrude out from the bottom surface of the groove.

5. The optical fiber coupler of claim 4, wherein the at least two first receiving holes are aligned with the positioning post.

6. The optical fiber coupler of claim 1, wherein the base body of the female port defines at least two second receiving holes at a surface towards the male port; the at least two female port lenses are received in corresponding second receiving holes; the at least two female port lenses protrude from the surface towards the male port.

7. The optical fiber coupler of claim 6, wherein the at least two second receiving holes are aligned with the positioning hole.

8. A male port comprising:
a main body comprising a connecting surface;
a positioning post mounted on the connecting surface;
at least one first transmitting optical fiber received in the main body;
at least one first receiving optical fiber received in the main body; and
at least two male port lenses mounted on the connecting surface,
wherein the at least one first transmitting optical fiber and the at least one first receiving optical fiber couple with corresponding male port lenses; the positioning post comprises a columnar body adjacent to the main body and a conical frustum body outwardly extends from an end of the columnar body away from the main body.

9. The male port of claim 8, wherein a diameter of a first end of the conical frustum body away from the columnar body is less than that of a second end of the conical frustum body adjacent to the columnar body.

10. The male port of claim 8, wherein the main body defines a groove at the connecting surface; the main body defines at least two first receiving holes at a bottom surface of the groove; the at least two male port lenses are received in corresponding first receiving holes; and the at least two male port lenses protrude out from the bottom surface of the groove.

11. The male port of claim 10, wherein the at least two first receiving holes are aligned with the positioning post.

12. A female port comprising:
a base body,
at least one second transmitting optical fiber received in the base body,
at least one second receiving optical fiber received in the base body,
at least two female port lenses coupled with the corresponding at least one second transmitting optical fiber and the at least one second receiving optical fiber,
wherein the base body defines a positioning hole at a sidewall; the positioning hole comprises a columnar portion and a conical frustum portion adjacent to the columnar portion, the columnar portion is located at a bottom of the positioning hole.

13. The female port of claim 12, wherein a diameter of a first end of the conical frustum portion adjacent to the columnar portion is less than that of a second end of the conical frustum portion away from the columnar portion.

14. The female port of claim 12, wherein the base body of the female port defines at least two second receiving holes at the sidewall; the at least two female port lenses are received in corresponding second receiving holes; the at least two female port lenses protrude from the sidewall.

15. The female port of claim 14, wherein the at least two second receiving holes are aligned with the positioning hole.
